(19) United States
(12) Patent Application Publication
(10) Pub. No.: US 2025/0128733 A1
(43) Pub. Date: Apr. 24, 2025

(54) METHOD FOR SHARING A PATHWAY OF A FIRST VEHICLE WHICH IS DRIVING A HOST LANE WITH A PATHWAY OF A SECOND VEHICLE WHICH IS DRIVING A TARGET LANE THROUGH A V2X COMMUNICATION AND CHANGING A DRIVING LANE OF THE FIRST VEHICLE FROM THE HOST LANE TO THE TARGET LANE AND COMPUTING DEVICE USING THE SAME

(71) Applicant: OBIGO INC., Seongnam-si (KR)

(72) Inventors: Young Suk LEE, Anyang-si (KR); Hak Jin LEE, Yongin-si (KR); Seon Ju LEE, Seongnam-si (KR)

(73) Assignee: OBIGO INC., Seongnam-si (KR)

(21) Appl. No.: 18/901,370

(22) Filed: Sep. 30, 2024

(30) Foreign Application Priority Data
Oct. 18, 2023 (KR) 10-2023-0139907

(51) Int. Cl. B60W 60/00; B60W 30/16; B60W 30/18

(52) U.S. Cl. CPC B60W 60/001; B60W 30/16; B60W 30/18163; B60W 2556/45; B60W 2756/10

(57) ABSTRACT

There is provided a method for (i) sharing a pathway of a first vehicle which is driving a host lane with a pathway of a second vehicle which is driving a target lane, which allows the first vehicle to generate an expected dynamic path, by referring to a first current position of the first vehicle and a second current position of a second vehicle, (ii) transmitting the expected dynamic path and a negotiation request to the second vehicle, by the first vehicle, thereby allowing the second vehicle to calculate an expected inter-vehicle distance between the first vehicle and the second vehicle and a degree of risk, which are used to decide whether to accept the negotiation request, and (iii) changing or maintaining a driving lane, by referring to information on whether to accept the negotiation request.

### CROSS REFERENCE TO RELATED APPLICATION

This present application claims the benefit of the earlier filing date of Korean non-provisional patent application No. 10-2023-0139907, filed on Oct. 18, 2023, the entire contents of which being incorporated herein by reference.

### FIELD OF THE DISCLOSURE

The present disclosure relates to a method for sharing a pathway of a first vehicle which is driving a host lane with a pathway of a second vehicle which is driving a target lane through a V2X communication and changing a driving lane of the first vehicle from the host lane to the target lane, and a computing device using the same.

### BACKGROUND OF THE DISCLOSURE

In order for an autonomous vehicle to reach its destination, a road condition should be analyzed by referring to real-time collected data obtained though sensors such as radar, LiDAR, and cameras while the autonomous vehicle is driving along a driving route created by a path planning, and then a safe and efficient route should be selected considering traffic conditions, speed limits, and lane changes. However, before 100% of vehicles on the road become autonomous vehicles, autonomous vehicles and non-autonomous vehicles may be indistinguishably driven on actual roads, which could lead to various problems.

For example, in case when to change lanes and whether to change lanes in an autonomous vehicle are determined solely based on information obtained through the sensors, it is highly probable that a dangerous situation can occur depending on driving styles or behavioral patterns of drivers of the non-autonomous vehicles.

In addition, by sharing Part II. PathPrediction information of J2735 BSM messages between the vehicles through a V2X communication, it is possible to predict the pathways of other vehicles through complex calculations, however, in case multiple vehicles approach in a complex road environment in a city, a path calculating process can cause an excessive load on an autonomous driving system.

Accordingly, the inventor of the present disclosure has developed a method for sharing planned pathways of vehicles as well as location information among the vehicles by using (i) a technology of Driving Route Sharing (DRS) capable of assisting in safe driving and eliminating risk factors in unpredictable situations and (ii) a system linked with the autonomous vehicles and connected vehicles.

### SUMMARY OF THE DISCLOSURE

It is an object of the present disclosure for solving such conventional problems.

It is another object of the present disclosure (i) to generate, by a first vehicle, an expected dynamic path from a first current position of the first vehicle to a safety target arrival position on a target lane by referring to the first current position of the first vehicle and a second current position of a second vehicle and transmit, by the first vehicle, a negotiation request to the second vehicle while sharing the expected dynamic path with the second vehicle, in response to a selection of the target lane as a lane change direction by the first vehicle which is driving a host lane, and (ii) to calculate, by the second vehicle, an expected inter-vehicle distance between the first vehicle and the second vehicle at an expected time of the first vehicle reaching a predetermined position on the target lane by referring to the first current position, the second current position, a velocity of the first vehicle, a velocity of the second vehicle, and the shared expected dynamic path, and calculate, by the second vehicle, a degree of risk by referring to the expected inter-vehicle distance.

It is still another object of the present disclosure (i) to decide, by the second vehicle, whether to accept the negotiation request by referring to the degree of risk and share, by the second vehicle, a decision on whether to accept the negotiation request with the first vehicle, and (ii) to change, by the first vehicle, the driving lane of the first vehicle to the target lane or maintain, by the first vehicle, the driving lane of the first vehicle to the host lane, by referring to the decision on whether to accept the negotiation request.

In order to accomplish objects above, representative structures of the present disclosure are described as follows:

In accordance with one aspect of the present disclosure there is provided a method for sharing a pathway of a first vehicle which is driving a host lane with a pathway of a second vehicle which is driving a target lane through a V2X communication and changing a driving lane of the first vehicle from the host lane to the target lane, comprising steps of: (a) in response to a selection of the target lane as a lane change direction by the first vehicle, generating, by the first vehicle, an expected dynamic path from a first current position of the first vehicle to a safety target arrival position on the target lane by referring to the first current position of the first vehicle and a second current position of the second vehicle, and transmitting, by the first vehicle, a negotiation request to the second vehicle while sharing the expected dynamic path with the second vehicle, thereby supporting the second vehicle to (i) calculate an expected inter-vehicle distance between the first vehicle and the second vehicle at an expected time of the first vehicle reaching a predetermined position on the target lane by referring to the first current position, the second current position, a velocity of the first vehicle, a velocity of the second vehicle, and the shared expected dynamic path, and (ii) calculate a degree of risk by referring to the expected inter-vehicle distance; and (b) supporting, by the first vehicle, the second vehicle to decide whether to accept the negotiation request by referring to the degree of risk, and changing, by the first vehicle, the driving lane of the first vehicle to the target lane or maintaining, by the first vehicle, the driving lane of the first vehicle to the host lane by referring to the information on whether to accept the negotiation request decided by the second vehicle.

As one example, at the step of (a), in response to the selection of the target lane as the lane change direction by the driving first vehicle, the first vehicle generates the expected dynamic path including a starting position of a lane change, an ending position of the lane change, and the safety target arrival position, wherein the starting position of the lane change is a position on the host lane where the first vehicle starts changing lanes from the host lane to the target lane, wherein the ending position of the lane change is a position on the target lane within a preset threshold close to a virtual center line of a driving direction of the target lane after the first vehicle enters the target lane, wherein the safety target arrival position is a position located a predetermined distance ahead in the driving direction of the target lane from the ending position of the lane change, and wherein the expected inter-vehicle distance from the second vehicle on the target lane following the first vehicle is controlled to exceed a preset safety distance.

As one example, at the step of (b), on condition that t₁ is defined by an expected time for the first vehicle to drive from the first current position to the ending position of the lane change, and a second expected position is defined by an expected position of the second vehicle after the second vehicle drives from the second current position in the target lane for the time t₁, the first vehicle supports the second vehicle to calculate the expected inter-vehicle distance by referring to the ending position of the lane change and the second expected position, wherein the degree of risk is determined as being below a preset risk threshold in case the expected inter-vehicle distance is greater than a present target safety distance, and wherein the degree of risk is determined to exceed the preset risk threshold in case the expected inter-vehicle distance is less than the present target safety distance.

As one example, at the step of (b), the first vehicle supports the second vehicle to refuse the negotiation request in case the degree of risk is determined as being above the preset risk threshold, and wherein the first vehicle supports the second vehicle to accept the negotiation request in case the degree of risk is determined as being the same as or below the preset risk threshold.

As one example, at the step of (b), in case the second vehicle accepts the negotiation request, and while the first vehicle is driving from the first current position to the ending position of the lane change, the first vehicle supports the second vehicle (i) to obtain each of expected positions of the first vehicle, each of expected positions of the second vehicle, each of velocities of the first vehicle, each of velocities of the second vehicle, and the expected dynamic path, for each unit time, (ii) to calculate the expected inter-vehicle distance in real time for each of the unit times, wherein the expected inter-vehicle distance is an expected distance between the first vehicle and the second vehicle at an expected time of the first vehicle reaching the ending position of the lane change according to the expected dynamic path, and (iii) to slow down the second vehicle in a specific unit time section in which the expected inter-vehicle distance is calculated to be smaller than the target safety distance.

As one example, at the step of (a), a distance which the second vehicle drives from the second current position to the second expected position is defined as d₂(m)={Vₜ*xᵣ/V_{H}}, wherein the target safety distance on a general road is defined as dₛ(m)={V₀(m/s)*3.6−15(m)}, and wherein the target safety distance on a highway is defined as dₛ(m)={V₀(m/s)*3.6}, wherein the Vₜ is a velocity of the second vehicle, the V_{H} is a velocity of the first vehicle, the xᵣ is a length of a remaining path to the ending position of the lane change for the first vehicle.

As one example, at the step of (a), a distance from the first current position to the starting position of the lane change is defined as x₁(m)={V₀(m/s)*3.6}+{V₀(m/s)*p}, wherein a distance from the starting position of the lane change to the ending position of the lane change is defined as x₂(m)={i+V(m/s)*p}, and wherein a distance from the ending position of the lane change to the safety target arrival position is defined as x₃(m)={c+V(m/s)*p}, wherein the V₀ is an initial velocity, the V is a velocity, the p is a weight for a safe distance according to a communication device, the i is a weight considering a driver's reaction time when changing lanes, and the c is a weight of an additional inter-vehicle distance considering variability in an actual environment.

As one example, at the step of (b), in case the second vehicle is an autonomous car, the first vehicle supports the second vehicle to automatically decide whether to accept the negotiation request by referring to the degree of risk, and wherein, in case the second vehicle is a connected car, the first vehicle supports the second vehicle to automatically decide or a driver of the second vehicle to manually decide whether to accept the negotiation request by referring to the degree of risk.

As one example, at the step of (b), in case the second vehicle accepts the negotiation request even on condition that the first vehicle driving the host lane has not passed the starting position of the lane change, the first vehicle changes the driving lane to the target lane after driving until the starting position of the lane change, and wherein, in case the second vehicle accepts the negotiation request on condition that the first vehicle driving the host lane has passed the starting position of the lane change, the first vehicle terminates a process of the negotiation request, maintains the driving lane as the host lane, and then resumes a subsequent negotiation request by referring to a relative subsequent position and a relative subsequent velocity between the first vehicle and the second vehicle.

As one example, at the step of (a), data of the expected dynamic path is used by adding a path structure of double x and double y to an extensible of a Basic Safety Message (BSM) used for exchanging safety-related information between the first vehicle and the second vehicle among a J2735 standard communication messages, wherein path information is generated in a dynamic array with ASN Sequence data, wherein the path is comprised of an array of pairs of x point and y point in an ENU coordinate system.

In accordance with another aspect of the present disclosure there is provided a computing device of a first vehicle for sharing a pathway of the first vehicle which is driving a host lane with a pathway of a second vehicle which is driving a target lane through a V2X communication and changing a driving lane of the first vehicle from the host lane to the target lane, comprising: at least one memory which saves instructions; and at least one processor configured to execute the instructions to perform processes of: (I) in response to a selection of the target lane as a lane change direction generating an expected dynamic path from a first current position of the first vehicle to a safety target arrival position on the target lane by referring to the first current position of the first vehicle and a second current position of the second vehicle, and transmitting a negotiation request to the second vehicle while sharing the expected dynamic path with the second vehicle, thereby supporting the second vehicle to (i) calculate an expected inter-vehicle distance between the first vehicle and the second vehicle at an expected time of the first vehicle reaching a predetermined position on the target lane by referring to the first current position, the second current position, a velocity of the first vehicle, a velocity of the second vehicle, and the shared expected dynamic path, and (ii) calculate a degree of risk by referring to the expected inter-vehicle distance; and (II) supporting the second vehicle to decide whether to accept the negotiation request by referring to the degree of risk, and changing the driving lane of the first vehicle to the target lane or maintaining the driving lane of the first vehicle to the host lane by referring to the information on whether to accept the negotiation request decided by the second vehicle.

As one example, at the process of (I), in response to the selection of the target lane as the lane change direction by the driving first vehicle, the processor of the first vehicle generates the expected dynamic path including a starting position of a lane change, an ending position of the lane change, and the safety target arrival position, wherein the starting position of the lane change is a position on the host lane where the first vehicle starts changing lanes from the host lane to the target lane, wherein the ending position of the lane change is a position on the target lane within a preset threshold close to a virtual center line of a driving direction of the target lane after the first vehicle enters the target lane, wherein the safety target arrival position is a position located a predetermined distance ahead in the driving direction of the target lane from the ending position of the lane change, and wherein the expected inter-vehicle distance from the second vehicle on the target lane following the first vehicle is controlled to exceed a preset safety distance.

As one example, at the process of (II), on condition that t₁ is defined by an expected time for the first vehicle to drive from the first current position to the ending position of the lane change, and a second expected position is defined by an expected position of the second vehicle after the second vehicle drives from the second current position in the target lane for the time t₁, the processor of the first vehicle supports the second vehicle to calculate the expected inter-vehicle distance by referring to the ending position of the lane change and the second expected position, wherein the degree of risk is determined as being below a preset risk threshold in case the expected inter-vehicle distance is greater than a present target safety distance, and wherein the degree of risk is determined to exceed the preset risk threshold in case the expected inter-vehicle distance is less than the present target safety distance.

As one example, at the process of (II), the processor of the first vehicle supports the second vehicle to refuse the negotiation request in case the degree of risk is determined as being above the preset risk threshold, and wherein the processor of the first vehicle supports the second vehicle to accept the negotiation request in case the degree of risk is determined as being the same as or below the preset risk threshold.

As one example, at the process of (II), in case the second vehicle accepts the negotiation request, and while the first vehicle is driving from the first current position to the ending position of the lane change, the processor of the first vehicle supports the second vehicle (i) to obtain each of expected positions of the first vehicle, each of expected positions of the second vehicle, each of velocities of the first vehicle, each of velocities of the second vehicle, and the expected dynamic path, for each unit time, (ii) to calculate the expected inter-vehicle distance in real time for each of the unit times, wherein the expected inter-vehicle distance is an expected distance between the first vehicle and the second vehicle at an expected time of the first vehicle reaching the ending position of the lane change according to the expected dynamic path, and (iii) to slow down the second vehicle in a specific unit time section in which the expected inter-vehicle distance is calculated to be smaller than the target safety distance.

As one example, at the process of (I), a distance which the second vehicle drives from the second current position to the second expected position is defined as d₂(m)={Vₜ*xᵣ/V_{H}}, wherein the target safety distance on a general road is defined as dₛ(m)={V₀(m/s)*3.6−15(m)}, and wherein the target safety distance on a highway is defined as dₛ (m)={V₀(m/s)*3.6}, wherein the Vₜ is a velocity of the second vehicle, the V_{H} is a velocity of the first vehicle, the xᵣ is a length of a remaining path to the ending position of the lane change for the first vehicle.

As one example, at the process of (I), a distance from the first current position to the starting position of the lane change is defined as x₁(m)={V₀(m/s)*3.6}+{V₀(m/s)*p}, wherein a distance from the starting position of the lane change to the ending position of the lane change is defined as x₂(m)={i+V(m/s)*p}, and wherein a distance from the ending position of the lane change to the safety target arrival position is defined as x₃(m)={c+V(m/s)*p}, wherein the V₀ is an initial velocity, the V is a velocity, the p is a weight for a safe distance according to a communication device, the i is a weight considering a driver's reaction time when changing lanes, and the c is a weight of an additional inter-vehicle distance considering variability in an actual environment.

As one example, at the process of (II), in case the second vehicle is an autonomous car, the processor of the first vehicle supports the second vehicle to automatically decide whether to accept the negotiation request by referring to the degree of risk, and wherein, in case the second vehicle is a connected car, the processor of the first vehicle supports the second vehicle to automatically decide or a driver of the second vehicle to manually decide whether to accept the negotiation request by referring to the degree of risk.

As one example, at the process of (II), in case the second vehicle accepts the negotiation request even on condition that the first vehicle driving the host lane has not passed the starting position of the lane change, the processor of the first vehicle changes the driving lane to the target lane after driving until the starting position of the lane change, and wherein, in case the second vehicle accepts the negotiation request on condition that the first vehicle driving the host lane has passed the starting position of the lane change, the processor of the first vehicle terminates a process of the negotiation request, maintains the driving lane as the host lane, and then resumes a subsequent negotiation request by referring to a relative subsequent position and a relative subsequent velocity between the first vehicle and the second vehicle.

As one example, at the process of (I), data of the expected dynamic path is used by adding a path structure of double x and double y to an extensible of a Basic Safety Message (BSM) used for exchanging safety-related information between the first vehicle and the second vehicle among a J2735 standard communication messages, wherein path information is generated in a dynamic array with ASN Sequence data, wherein the path is comprised of an array of pairs of x point and y point in an ENU coordinate system.

### BRIEF DESCRIPTION OF THE DRAWINGS

The accompanying drawings used to explain example embodiments of the present disclosure are only part of example embodiments of the present disclosure and other drawings can be obtained based on the accompanying drawings by those skilled in the art of the present disclosure without inventive work.

FIG. 1 is a drawing schematically illustrating a computing device for sharing a pathway of a first vehicle which is driving a host lane with a pathway of a second vehicle which is driving a target lane through a V2X communication and changing a driving lane of the first vehicle from the host lane to the target lane.

FIG. 2 is a flow chart schematically illustrating a process of sharing a pathway of the first vehicle which is driving the host lane with the pathway of the second vehicle which is driving the target lane through the V2X communication and changing the driving lane of the first vehicle from the host lane to the target lane.

FIG. 3 is a drawing schematically illustrating a state of generating, by the first vehicle, an expected dynamic path, and transmitting, by the first vehicle, a negotiation request to the second vehicle while sharing the expected dynamic path with the second vehicle.

FIG. 4 is a drawing schematically illustrating a state of supporting the second vehicle to calculate the expected inter-vehicle distance between the first vehicle and the second vehicle at an expected time of the first vehicle reaching the ending position of the lane change according to the expected dynamic path and to calculate a degree of risk by referring to the expected inter-vehicle distance.

### DETAILED DESCRIPTION OF THE PREFERRED EMBODIMENTS

The following detailed description of the present disclosure refers to the accompanying drawings, which show by way of illustration a specific embodiment in which the present disclosure may be practiced, in order to clarify the objects, technical solutions and advantages of the present disclosure. These embodiments are described in sufficient detail to enable those skilled in the art to practice the present disclosure.

Besides, in the detailed description and claims of the present disclosure, a term “include” and its variations are not intended to exclude other technical features, additions, components, or steps. Other objects, benefits and features of the present disclosure will be revealed to one skilled in the art, partially from the specification and partially from the implementation of the present disclosure. The following examples and drawings will be provided as examples, but they are not intended to limit the present disclosure.

Moreover, the present disclosure covers all possible combinations of example embodiments indicated in this specification. It is to be understood that the various embodiments of the present disclosure, although different, are not necessarily mutually exclusive. For example, a particular feature, structure, or characteristic described herein in connection with one embodiment may be implemented within other embodiments without departing from the spirit and scope of the present disclosure. In addition, it is to be understood that the position or arrangement of individual elements within each disclosed embodiment may be modified without departing from the spirit and scope of the present disclosure. The following detailed description is, therefore, not to be taken in a limiting sense, and the scope of the present disclosure is defined only by the appended claims, appropriately interpreted, along with the full range of equivalents to which the claims are entitled. In the drawings, like numerals refer to the same or similar functionality throughout the several views.

To allow those skilled in the art to carry out the present disclosure easily, the example embodiments of the present disclosure will be explained by referring to attached diagrams in detail as shown below.

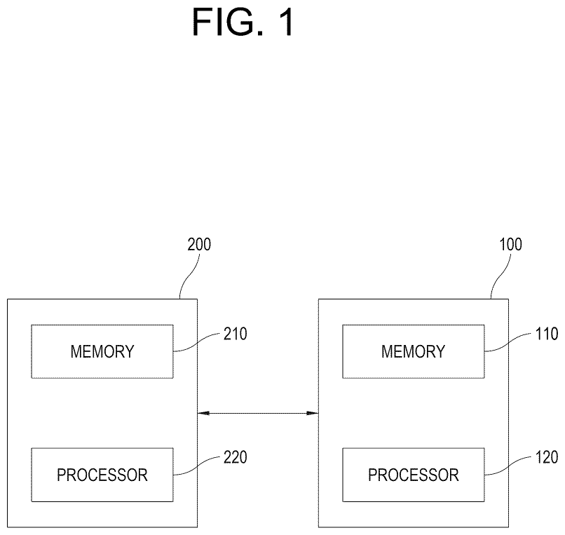

FIG. 1 is a drawing schematically illustrating a computing device for sharing a pathway of a first vehicle which is driving a host lane with a pathway of a second vehicle which is driving a target lane through a V2X communication and changing a driving lane of the first vehicle from the host lane to the target lane in accordance with one example embodiment of the present disclosure.

As illustrated in FIG. 1, a memory 110 of a first computing device 100 of the first vehicle stores at least one instruction which is performed by a processor 120. In detail, the instruction is code generated to command the first computing device 100 to function in a specific way, and the instruction may be stored in machine-readable memories or machine-decipherable memories. The instruction can perform processes which are explained later.

Further, the processor 120 of the first computing device 100 of the first vehicle may include following hardware components: a micro processing unit, i.e., MPU, a central processing unit, i.e., CPU, a cache memory, and a data bus. Further, the first computing device 100 also includes following software components: at least one operation system and at least one application on specific purposes.

Also, the first computing device 100 may be interlinked with at least one database. Herein, the database may include at least one type of storage medium among following types: a flash memory type, a hard disk type, a multimedia card micro type, a card type memory (for instance, an SD memory or an XD memory), a random-access memory, i.e., RAM, a static random-access memory, i.e., SRAM, a read-only memory, i.e., ROM, an electrically erasable programmable read-only memory, i.e., EEPROM, a programmable read-only memory, i.e., PROM, a magnetic memory, a magnetic disk, an optical disk, but it is not limited thereto, such that the database also include all storage mediums capable of saving data. Also, the database may be configured in a separated place from the first computing device 100. In contrary, the database may also be configured inside the first computing device 100 to send data to the first computing device 100 or to write received data. For convenience, the number of the database may be one but two or more as the case may be.

Next, as illustrated in FIG. 1, a memory 210 of a second computing device 200 of a second vehicle stores at least one instruction which is performed by a processor 220. In detail, the instruction is code generated to command the second computing device 200 to function in a specific way, and the instruction may be stored in machine-readable memories or machine-decipherable memories. The instruction can perform processes which are explained later.

Further, the processor 220 of the second computing device 200 of the second vehicle may include following hardware components: the micro processing unit, i.e., MPU, the central processing unit, i.e., CPU, the cache memory, and the data bus. Further, the second computing device 200 also includes following software components: at least one operation system and at least one application on specific purposes.

Also, the second computing device 200 may be interlinked with at least one database. Herein, the database may include at least one type of storage medium among following types: a flash memory type, the hard disk type, the multimedia card micro type, the card type memory (for instance, an SD memory or an XD memory), the random-access memory, i.e., RAM, the static random-access memory, i.e., SRAM, the read-only memory, i.e., ROM, the electrically erasable programmable read-only memory, i.e., EEPROM, the programmable read-only memory, i.e., PROM, the magnetic memory, the magnetic disk, the optical disk, but it is not limited thereto, such that the database also include all storage mediums capable of saving data. Also, the database may be configured in a separated place from the second computing device 200. In contrary, the database may also be configured inside the second computing device 200 to send data to the second computing device 200 or to write received data. For convenience, the number of the database may be one but two or more as the case may be.

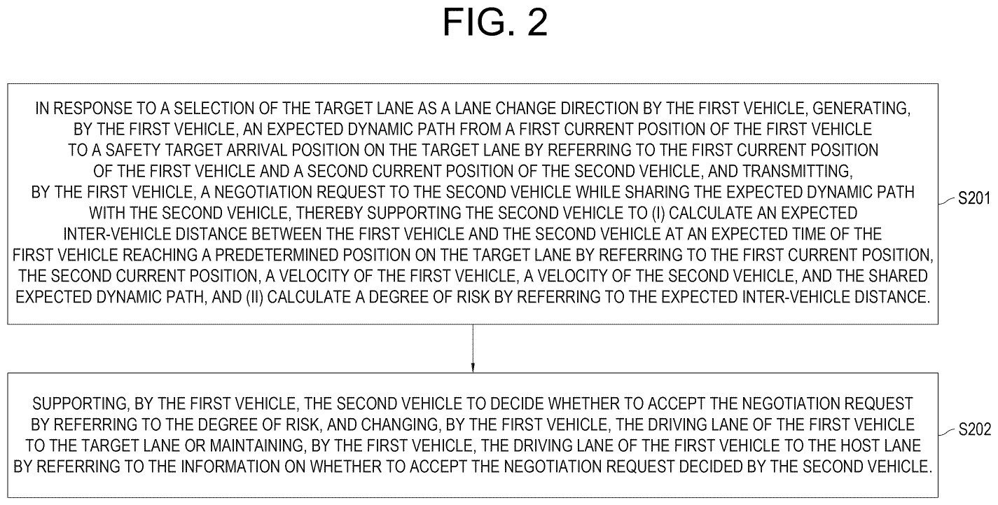

In accordance with present disclosure, a method using the first computing device 100 and the second computing device 200 can be explained by referring to FIG. 2.

FIG. 2 is a flow chart schematically illustrating the process of sharing the pathway of the first vehicle which is driving the host lane with a pathway of the second vehicle which is driving the target lane through the V2X communication and changing the driving lane of the first vehicle from the host lane to the target lane.

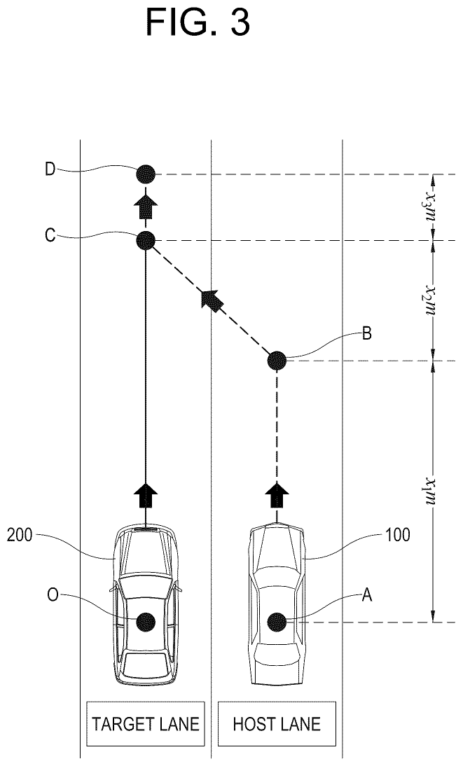

Referring to FIG. 2, when the first vehicle 100 driving in the host lane changes its driving lane to the target lane, the first vehicle 100 generates an expected dynamic path from a first current position of the first vehicle 100 to a safety target arrival position on the target lane by referring to the first current position of the first vehicle 100 and a second current position of the second vehicle 200, and transmits a negotiation request to the second vehicle 200 while sharing the expected dynamic path with the second vehicle 200, thereby supporting the second vehicle 200 to (i) calculate an expected inter-vehicle distance between the first vehicle 100 and the second vehicle 200 at an expected time of the first vehicle 100 reaching a predetermined position on the target lane by referring to the first current position, the second current position, a velocity of the first vehicle 100, a velocity of the second vehicle 200, and the shared expected dynamic path, and (ii) calculate a degree of risk by referring to the expected inter-vehicle distance at a step of S201. This will be explained by referring to FIG. 3 in detail as shown below.

FIG. 3 is a drawing schematically illustrating a state of generating, by the first vehicle, the expected dynamic path, and transmitting, by the first vehicle, the negotiation request to the second vehicle while sharing the expected dynamic path with the second vehicle.

First, information such as velocity, latitude and longitude of a vehicle, which is required to run an identical DRS (Driving Route Sharing) function in an autonomous vehicle or a connected vehicle can be received through CAN (Controller Area Network) interface, GPS interface, and OBE (On Board Diagnostics) interface in a module of the vehicle.

In addition, data of the expected dynamic path is used by adding a path structure of double x and double y to an extensible of a Basic Safety Message (BSM) used for exchanging safety-related information between the vehicles among a J2735 standard communication messages. Further, path information is generated in a dynamic array with ASN Sequence data, and Path is comprised of an array of pairs of x point and y point in an ENU coordinate system.

By referring to the step of S201 and FIG. 3, in order to change a driving lane of the first vehicle 100 from the host lane to the target lane, the computing device of the first vehicle 100 generates the expected dynamic path including a starting position B of a lane change, an ending position C of the lane change, and a safety target arrival position D.

In detail, the starting position B of the lane change is a position on the host lane where the first vehicle 100 starts changing lanes from the host lane to the target lane, the ending position C of the lane change is a position on the target lane within a preset threshold close to a virtual center line of a driving direction of the target lane after the first vehicle 100 enters the target lane, and the safety target arrival position D is a position located a predetermined distance ahead in the driving direction of the target lane from the ending position C of the lane change. In particular, the expected inter-vehicle distance from the second vehicle 200 on the target lane following the first vehicle 100 during driving is controlled to exceed a preset safety distance at the safety target arrival position D.

Herein, a distance from the first current position to the starting position of the lane change is defined as x₁(m)={V₀(m/s)*3.6}+{V₀(m/s)*p}, a distance from the starting position of the lane change to the ending position of the lane change is defined as x₂(m)={i+V(m/s)*p}, and a distance from the ending position of the lane change to the safety target arrival position is defined as x₃(m)={c+V(m/s)*p}, wherein the V₀ is an initial velocity, the V is a velocity, the p is a weight for a safe distance according to a communication device, the i is a weight considering a driver's reaction time when changing lanes, and the c is a weight of an additional inter-vehicle distance considering variability in an actual environment.

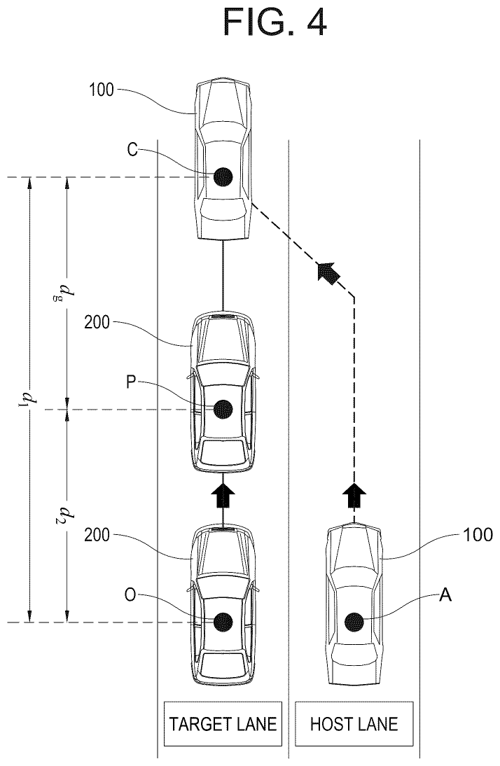

FIG. 4 is a drawing schematically illustrating a state of supporting the second vehicle to calculate the expected inter-vehicle distance between the first vehicle and the second vehicle at an expected time of the first vehicle reaching the ending position C of the lane change according to the expected dynamic path and to calculate a degree of risk by referring to the expected inter-vehicle distance.

First, a target safety distance dₛ, which serves as the standard for setting the distance between vehicles for safety, is set according to the Road Traffic Authority's guideline for safety inter-vehicle distance. The target safety distance on a general road is defined as dₛ(m)={V₀(m/s)*3.6−15(m)}, and the target safety distance on a highway is defined as dₛ(m)={V₀(m/s)*3.6}, wherein V₀ is an initial velocity, but the target safety distance dₛ is not limited thereto.

Back to the step of S201, on condition that t₁ is defined by an expected time for the first vehicle 100 to drive from the first current position A to the ending position C of the lane change, and a second expected position P is defined by an expected position of the second vehicle 200 after the second vehicle 200 drives from the second current position O in the target lane for the time t₁, a distance which the second vehicle 200 drives from the second current position O to the second expected position P is defined as d₂(m)={Vₜ*xᵣ/V_{H}}, wherein the V_{H} is a velocity of the first vehicle, the Vₜ is a velocity of the second vehicle, the xᵣ is a length of a remaining path to the ending position of the lane change for the first vehicle.

In addition, the first vehicle 100 supports the second vehicle 200 to calculate the expected inter-vehicle distance d_{g} by referring to the ending position C of the lane change and the second expected position P. Further, the degree of risk is determined as being equal to or smaller than a preset risk threshold in case the expected inter-vehicle distance d_{g} is greater than the target safety distance dₛ, and the degree of risk is determined to exceed the preset risk threshold in case the expected inter-vehicle distance d_{g} is equal to or smaller than the target safety distance dₛ.

Next, the first vehicle 100 can support the second vehicle 200 to decide whether to accept the negotiation request by referring to the degree of risk. Further, the first vehicle 100 can change its driving lane to the target lane or maintain its driving lane to the host lane by referring to the information on whether to accept the negotiation request decided by the second vehicle 200.

Herein, the second vehicle 200 may refuse the negotiation request in case the degree of risk is determined as being above the preset risk threshold by referring to the degree of risk. When the degree of risk is determined as being the same as or below the preset risk threshold, the second vehicle 200 may automatically decide whether to accept the negotiation request by referring to the preset safety standard in case the second vehicle is an autonomous car, and the second vehicle 200 may automatically decide whether to accept the negotiation request by referring to the preset safety standard or manually decide whether to accept the negotiation request by a driver of the second vehicle 200 in case the second vehicle 200 is a connected car.

In addition, in case the second vehicle 200 accepts the negotiation request, the second vehicle 200 (i) obtains each of expected positions of the first vehicle 100, each of expected positions of the second vehicle 200, each of velocities of the first vehicle 100, each of velocities of the second vehicle 200 and the expected dynamic path, for each unit time, while the first vehicle 100 is driving from the first current position A to the ending position C of the lane change, (ii) calculates the expected inter-vehicle distance d_{g} in real time for each unit time, wherein the expected inter-vehicle distance is an expected distance between the first vehicle 100 and the second vehicle 200 at an expected time of the first vehicle 100 reaching the ending position of the lane change, and wherein the expected inter-vehicle distance d_{g} can be changed to a different value in real time as the velocity of the first vehicle 100 and the velocity of the second vehicle 200 change in real time, and (iii) slows down for a safe driving from a specific unit time at which the expected inter-vehicle distance d_{g} is calculated to be smaller than the target safety distance dₛ.

Also, in case the second vehicle 200 accepts the negotiation request even on condition that the first vehicle 100 driving the host lane has not passed the starting position B of the lane change, the first vehicle 100 changes its driving lane to the target lane after driving until the starting position B of the lane change, and in case the second vehicle 200 accepts the negotiation request on condition that the first vehicle 100 driving the host lane has passed the starting position B of the lane change, the first vehicle 100 may terminate a process of the negotiation request, maintain the driving lane as the host lane, and then resume a subsequent negotiation request by referring to a relative subsequent position and a relative subsequent velocity between the first vehicle 100 and the second vehicle 200.

According to one example embodiment of the present disclosure, it is an effect of the present disclosure (i) to generate, by the first vehicle, an expected dynamic path from a first current position of the first vehicle to a safety target arrival position on the target lane by referring to the first current position of the first vehicle and a second current position of the second vehicle, and transmit, by the first vehicle, a negotiation request to the second vehicle while sharing the expected dynamic path with the second vehicle, in response to a selection of the target lane as a lane change direction by a first vehicle which is driving a host lane, and (ii) to calculate, by the second vehicle, an expected inter-vehicle distance between the first vehicle and the second vehicle at an expected time of the first vehicle reaching a predetermined position on the target lane by referring to the first current position, the second current position, a velocity of the first vehicle, a velocity of the second vehicle, and the shared expected dynamic path, and calculate, by the second vehicle, a degree of risk by referring to the expected inter-vehicle distance.

According to another example embodiment of the present disclosure, it is still another effect of the present disclosure (i) to decide, by the second vehicle, whether to accept the negotiation request by referring to the degree of risk and share, by the second vehicle, a decision on whether to accept the negotiation request with the first vehicle, and (ii) to change, by the first vehicle, the driving lane of the first vehicle to the target lane or maintain, by the first vehicle, the driving lane of the first vehicle to the host lane, by referring to the decision on whether to accept the negotiation request.

The suggested processes, which is in accordance with one example embodiment of the present disclosure, can be implemented in a programmed command which can be performed by various computer component, and can be written on a machine-decipherable medium. The machine-decipherable medium may include program commands, data files, data structures, or combination of aforementioned elements. The program commands written on the machine-decipherable medium may be specifically designed or complied only to perform aforementioned processes or may be allowed to use after notices to those skilled in the art of present disclosure. The machine-decipherable medium can be one of follow media: a hard disk, a magnetic medium such as a floppy disk or a magnetic tape, an optical medium such as CD-ROM and DVD, a magnetooptical medium such as a floptical disk, a ROM, a RAM, a Flash memory, and other hardware components which are designed to save and perform the program commands. The program commands may be written in one of complied languages or one of interpreted languages. The hardware device may be configured to perform the process of this disclosure as at least one or more software module, and vice versa.

As seen above, the present disclosure has been explained by specific matters such as detailed components, limited embodiments, and drawings. While the invention has been shown and described with respect to the preferred embodiments, it, however, will be understood by those skilled in the art that various changes and modification may be made without departing from the spirit and scope of the invention as defined in the following claims.

Accordingly, the thought of the present disclosure must not be confined to the explained embodiments, and the following patent claims as well as everything including variations equal or equivalent to the patent claims pertain to the category of the thought of the present disclosure.

What is claimed is:

1. A method for sharing a pathway of a first vehicle which is driving a host lane with a pathway of a second vehicle which is driving a target lane through a V2X communication and changing a driving lane of the first vehicle from the host lane to the target lane, comprising steps of:
(a) in response to a selection of the target lane as a lane change direction by the first vehicle, generating, by the first vehicle, an expected dynamic path from a first current position of the first vehicle to a safety target arrival position on the target lane by referring to the first current position of the first vehicle and a second current position of the second vehicle, and transmitting, by the first vehicle, a negotiation request to the second vehicle while sharing the expected dynamic path with the second vehicle, thereby supporting the second vehicle to (i) calculate an expected inter-vehicle distance between the first vehicle and the second vehicle at an expected time of the first vehicle reaching a predetermined position on the target lane by referring to the first current position, the second current position, a velocity of the first vehicle, a velocity of the second vehicle, and the shared expected dynamic path, and (ii) calculate a degree of risk by referring to the expected inter-vehicle distance; and
(b) supporting, by the first vehicle, the second vehicle to decide whether to accept the negotiation request by referring to the degree of risk, and changing, by the first vehicle, the driving lane of the first vehicle to the target lane or maintaining, by the first vehicle, the driving lane of the first vehicle to the host lane by referring to the information on whether to accept the negotiation request decided by the second vehicle.

2. The method of claim 1, wherein, at the step of (a), in response to the selection of the target lane as the lane change direction by the driving first vehicle, the first vehicle generates the expected dynamic path including a starting position of a lane change, an ending position of the lane change, and the safety target arrival position,
wherein the starting position of the lane change is a position on the host lane where the first vehicle starts changing lanes from the host lane to the target lane, wherein the ending position of the lane change is a position on the target lane within a preset threshold close to a virtual center line of a driving direction of the target lane after the first vehicle enters the target lane, wherein the safety target arrival position is a position located a predetermined distance ahead in the driving direction of the target lane from the ending position of the lane change, and wherein the expected inter-vehicle distance from the second vehicle on the target lane following the first vehicle is controlled to exceed a preset safety distance.

3. The method of claim 2, wherein, at the step of (b), on condition that t₁ is defined by an expected time for the first vehicle to drive from the first current position to the ending position of the lane change, and a second expected position is defined by an expected position of the second vehicle after the second vehicle drives from the second current position in the target lane for the time t₁, the first vehicle supports the second vehicle to calculate the expected inter-vehicle distance by referring to the ending position of the lane change and the second expected position, wherein the degree of risk is determined as being below a preset risk threshold in case the expected inter-vehicle distance is greater than a present target safety distance, and wherein the degree of risk is determined to exceed the preset risk threshold in case the expected inter-vehicle distance is less than the present target safety distance.

4. The method of claim 3, wherein, at the step of (b), the first vehicle supports the second vehicle to refuse the negotiation request in case the degree of risk is determined as being above the preset risk threshold, and wherein the first vehicle supports the second vehicle to accept the negotiation request in case the degree of risk is determined as being the same as or below the preset risk threshold.

5. The method of claim 3, wherein, at the step of (b), in case the second vehicle accepts the negotiation request, and while the first vehicle is driving from the first current position to the ending position of the lane change, the first vehicle supports the second vehicle (i) to obtain each of expected positions of the first vehicle, each of expected positions of the second vehicle, each of velocities of the first vehicle, each of velocities of the second vehicle, and the expected dynamic path, for each unit time, (ii) to calculate the expected inter-vehicle distance in real time for each of the unit times, wherein the expected inter-vehicle distance is an expected distance between the first vehicle and the second vehicle at an expected time of the first vehicle reaching the ending position of the lane change according to the expected dynamic path, and (iii) to slow down the second vehicle in a specific unit time section in which the expected inter-vehicle distance is calculated to be smaller than the target safety distance.

6. The method of claim 3, wherein, at the step of (a), a distance which the second vehicle drives from the second current position to the second expected position is defined as d₂(m)={Vₜ*xᵣ/V_{H}}, wherein the target safety distance on a general road is defined as dₛ(m)={V₀(m/s)*3.6−15(m)}, and wherein the target safety distance on a highway is defined as dₛ(m)={V₀(m/s)*3.6},
wherein the Vₜ is a velocity of the second vehicle, the V_{H} is a velocity of the first vehicle, the xᵣ is a length of a remaining path to the ending position of the lane change for the first vehicle.

7. The method of claim 2, wherein, at the step of (a), a distance from the first current position to the starting position of the lane change is defined as x₁(m)={V₀(m/s)*3.6}+{V₀(m/s)*p}, wherein a distance from the starting position of the lane change to the ending position of the lane change is defined as x₂(m)={i+V(m/s)*p}, and wherein a distance from the ending position of the lane change to the safety target arrival position is defined as x₃(m)={c+V(m/s)*p},
wherein the V₀ is an initial velocity, the V is a velocity, the p is a weight for a safe distance according to a communication device, the i is a weight considering a driver's reaction time when changing lanes, and the c is a weight of an additional inter-vehicle distance considering variability in an actual environment.

8. The method of claim 1, wherein, at the step of (b), in case the second vehicle is an autonomous car, the first vehicle supports the second vehicle to automatically decide whether to accept the negotiation request by referring to the degree of risk, and wherein, in case the second vehicle is a connected car, the first vehicle supports the second vehicle to automatically decide or a driver of the second vehicle to manually decide whether to accept the negotiation request by referring to the degree of risk.

9. The method of claim 1, wherein, at the step of (b), in case the second vehicle accepts the negotiation request even on condition that the first vehicle driving the host lane has not passed the starting position of the lane change, the first vehicle changes the driving lane to the target lane after driving until the starting position of the lane change, and wherein, in case the second vehicle accepts the negotiation request on condition that the first vehicle driving the host lane has passed the starting position of the lane change, the first vehicle terminates a process of the negotiation request, maintains the driving lane as the host lane, and then resumes a subsequent negotiation request by referring to a relative subsequent position and a relative subsequent velocity between the first vehicle and the second vehicle.

10. The method of claim 1, wherein, at the step of (a), data of the expected dynamic path is used by adding a path structure of double x and double y to an extensible of a Basic Safety Message (BSM) used for exchanging a safety-related information between the first vehicle and the second vehicle among a J2735 standard communication messages, wherein path information is generated in a dynamic array with ASN Sequence data, wherein the path is comprised of an array of pairs of x point and y point in an ENU coordinate system.

11. A computing device of a first vehicle for sharing a pathway of the first vehicle which is driving a host lane with a pathway of a second vehicle which is driving a target lane through a V2X communication and changing a driving lane of the first vehicle from the host lane to the target lane, comprising:
at least one memory which saves instructions; and
at least one processor configured to execute the instructions to perform processes of: (I) in response to a selection of the target lane as a lane change direction generating an expected dynamic path from a first current position of the first vehicle to a safety target arrival position on the target lane by referring to the first current position of the first vehicle and a second current position of the second vehicle, and transmitting a negotiation request to the second vehicle while sharing the expected dynamic path with the second vehicle, thereby supporting the second vehicle to (i) calculate an expected inter-vehicle distance between the first vehicle and the second vehicle at an expected time of the first vehicle reaching a predetermined position on the target lane by referring to the first current position, the second current position, a velocity of the first vehicle, a velocity of the second vehicle, and the shared expected dynamic path, and (ii) calculate a degree of risk by referring to the expected inter-vehicle distance; and (II) supporting the second vehicle to decide whether to accept the negotiation request by referring to the degree of risk, and changing the driving lane of the first vehicle to the target lane or maintaining the driving lane of the first vehicle to the host lane by referring to the information on whether to accept the negotiation request decided by the second vehicle.

12. The computing device of claim 11, wherein, at the process of (I), in response to the selection of the target lane as the lane change direction by the driving first vehicle, the processor of the first vehicle generates the expected dynamic path including a starting position of a lane change, an ending position of the lane change, and the safety target arrival position,
wherein the starting position of the lane change is a position on the host lane where the first vehicle starts changing lanes from the host lane to the target lane, wherein the ending position of the lane change is a position on the target lane within a preset threshold close to a virtual center line of a driving direction of the target lane after the first vehicle enters the target lane, wherein the safety target arrival position is a position located a predetermined distance ahead in the driving direction of the target lane from the ending position of the lane change, and wherein the expected inter-vehicle distance from the second vehicle on the target lane following the first vehicle is controlled to exceed a preset safety distance.

13. The computing device of claim 12, wherein, at the process of (II), on condition that t₁ is defined by an expected time for the first vehicle to drive from the first current position to the ending position of the lane change, and a second expected position is defined by an expected position of the second vehicle after the second vehicle drives from the second current position in the target lane for the time t₁, the processor of the first vehicle supports the second vehicle to calculate the expected inter-vehicle distance by referring to the ending position of the lane change and the second expected position, wherein the degree of risk is determined as being below a preset risk threshold in case the expected inter-vehicle distance is greater than a present target safety distance, and wherein the degree of risk is determined to exceed the preset risk threshold in case the expected inter-vehicle distance is less than the present target safety distance.

14. The computing device of claim 13, wherein, at the process of (II), the processor of the first vehicle supports the second vehicle to refuse the negotiation request in case the degree of risk is determined as being above the preset risk threshold, and wherein the processor of the first vehicle supports the second vehicle to accept the negotiation request in case the degree of risk is determined as being the same as or below the preset risk threshold.

15. The computing device of claim 13, wherein, at the process of (II), in case the second vehicle accepts the negotiation request, and while the first vehicle is driving from the first current position to the ending position of the lane change, the processor of the first vehicle supports the second vehicle (i) to obtain each of expected positions of the first vehicle, each of expected positions of the second vehicle, each of velocities of the first vehicle, each of velocities of the second vehicle, and the expected dynamic path, for each unit time, (ii) to calculate the expected inter-vehicle distance in real time for each of the unit times, wherein the expected inter-vehicle distance is an expected distance between the first vehicle and the second vehicle at an expected time of the first vehicle reaching the ending position of the lane change according to the expected dynamic path, and (iii) to slow down the second vehicle in a specific unit time section in which the expected inter-vehicle distance is calculated to be smaller than the target safety distance.

16. The computing device of claim 13, wherein, at the process of (I), a distance which the second vehicle drives from the second current position to the second expected position is defined as d₂(m)={Vₜ*xᵣ/V_{H}}, wherein the target safety distance on a general road is defined as dₛ(m)={V₀(m/s)*3.6−15 (m)}, and wherein the target safety distance on a highway is defined as dₛ(m)={V₀(m/s)*3.6},
wherein the Vₜ is a velocity of the second vehicle, the V_{H} is a velocity of the first vehicle, the xᵣ is a length of a remaining path to the ending position of the lane change for the first vehicle.

17. The computing device of claim 12, wherein, at the process of (I), a distance from the first current position to the starting position of the lane change is defined as x₁(m)={V₀(m/s)*3.6}+{V₀(m/s)*p}, wherein a distance from the starting position of the lane change to the ending position of the lane change is defined as x₂(m)={i+V(m/s)*p}, and wherein a distance from the ending position of the lane change to the safety target arrival position is defined as x₃(m)={c+V(m/s)*p},
wherein the V₀ is an initial velocity, the V is a velocity, the p is a weight for a safe distance according to a communication device, the i is a weight considering a driver's reaction time when changing lanes, and the c is a weight of an additional inter-vehicle distance considering variability in an actual environment.

18. The computing device of claim 11, wherein, at the process of (II), in case the second vehicle is an autonomous car, the processor of the first vehicle supports the second vehicle to automatically decide whether to accept the negotiation request by referring to the degree of risk, and wherein, in case the second vehicle is a connected car, the processor of the first vehicle supports the second vehicle to automatically decide or a driver of the second vehicle to manually decide whether to accept the negotiation request by referring to the degree of risk.

19. The computing device of claim 11, wherein, at the process of (II), in case the second vehicle accepts the negotiation request even on condition that the first vehicle driving the host lane has not passed the starting position of the lane change, the processor of the first vehicle changes the driving lane to the target lane after driving until the starting position of the lane change, and wherein, in case the second vehicle accepts the negotiation request on condition that the first vehicle driving the host lane has passed the starting position of the lane change, the processor of the first vehicle terminates a process of the negotiation request, maintains the driving lane as the host lane, and then resumes a subsequent negotiation request by referring to a relative subsequent position and a relative subsequent velocity between the first vehicle and the second vehicle.

20. The computing device of claim 11, wherein, at the process of (I), data of the expected dynamic path is used by adding a path structure of double x and double y to an extensible of a Basic Safety Message (BSM) used for exchanging safety-related information between the first vehicle and the second vehicle among a J2735 standard communication messages, wherein path information is generated in a dynamic array with ASN Sequence data, wherein the path is comprised of an array of pairs of x point and y point in an ENU coordinate system.
